(19) United States
(12) Patent Application Publication
(10) Pub. No.: US 2006/0264132 A1
(43) Pub. Date: Nov. 23, 2006

(54) High performance aerogel composites

(76) Inventors: Daniel L. Leeser, Framingham, MA (US); Christopher Blair, Littleton, CO (US); Roxana Trifu, Shrewsbury, MA (US); George L. Gould, Mendon, MA (US)

Correspondence Address: ASPEN AEROGELS INC.;IP DEPARTMENT, 30 FORBES ROAD, BLDG. B, NORTHBOROUGH, MA, 01532, US

(21) Appl. No.: 11/134,029

(22) Filed: May 21, 2005

(51) Int. Cl. B32B 5/02; B32B 5/22; B32B 27/02; B32B 17/02; D04H 1/46; D04H 1/00

(52) U.S. Cl. 442/77; 442/59; 442/164; 442/172; 442/152; 442/402; 442/417; 442/131

(57) ABSTRACT

The current invention discloses various materials, specifically composites comprising aerogels and fiber reinforced forms thereof. The invention further teaches the methods of making such composites along with different additives that can be added in the composites to derive desired property enhancements.

### RELATED APPLICATION DATA

This application claims the benefit of U.S. provisional application No. 60/572,888 filed on May 20, 2004 which is incorporated by reference in its entirety.

### FIELD OF INVENTION

The current invention relates to composites of low density nanoporous materials such as silica aerogels along with fibers in coherent structures.

### DESCRIPTION OF THE INVENTION

Aerogels describe a class of material based upon their structure, namely low density, open cell structures, large surface areas (often 600 m²/g or higher) and sub-nanometer scale pore sizes. Supercritical and subcritical fluid extraction technologies are commonly used to extract the fluid from the fragile cells of the material. A variety of different aerogel compositions are known and may be inorganic or organic. Inorganic aerogels are generally based upon metal alkoxides and include materials such as silica, carbides, and alumina. Organic aerogels include carbon aerogels and polymeric aerogels such as polyimides.

Low density aerogels (0.02-0.2 g/cc) based upon silica are excellent insulators, better than the best rigid foams with thermal conductivities of 15 mW/m-K and below at 100° F. and atmospheric pressure. Aerogels function as thermal insulators primarily by minimizing conduction (low density, tortuous path for heat transfer through the nanostructures), convection (very small pore sizes minimize convection), and radiation (IR suppressing dopants may easily be dispersed throughout the aerogel matrix). Depending on the formulation, they can function well at temperatures of 550° C. and above. However, in a monolithic state they tend to be fragile and brittle and are thus not well suited for most applications outside of the laboratory.

In the broadest sense, i e., when regarded as “gels with air as the dispersant,” aerogels are manufactured by drying a suitable gel. When used in this sense, the term “aerogel” includes aerogels in the narrower sense, such as xerogels and cryogels. A gel is designated as an aerogel in the narrower sense if the liquid is removed from the gel at temperatures above the critical temperature and starting from pressures that are above the critical pressure. In contrast to this, if the liquid is removed from the gel sub-critically, for example with the formation of a liquid-vapour boundary phase, then the resulting gel is, in many instances, referred to as xerogel. It should be noted that the aerogels according to the present invention are aerogels in the sense that they are gels with air as the dispersant.

U.S. patent application Ser. No. 10/034,296 assigned to the same entity the current invention, teaches methods of preparing aerogel fiber composites and is herein incorporated by reference in its entirety. The composites of the current invention may be used in thermal and acoustic insulation, energy absorption, filtration, energy storage and various other advanced applications. Several embodiments of the current invention can be better understood with the understandings of basic sol-gel chemistry known to any person of ordinary skill in the art and are also captured in references like Brinker et al, Sol-gel Science, Academic Press, 1990 which is also incorporated by reference here.

The sol as used in the current invention can be prepared with an inorganic, organic or a combination of inorganic/organic hybrid materials. The inorganic materials can include zirconia, yttria, hafnia, alumina, titania, ceria, and silica, magnesium oxide, calcium oxide, magnesium fluoride, calcium fluoride, and any combinations of the above. They can be in related forms like metal alkoxides, silicic acid, sodium silicate and the like. Organic materials can include polyacrylates, polymethacrylates, polyolefins, polystyrenes, polyacrylonitriles, polyurethanes, polyimides, polyfurfural alcohol, phenol furfuryl alcohol, melamine formaldehydes, resorcinol formaldehydes, cresol formaldehyde, phenol formaldehyde, polyvinyl alcohol dialdehyde, polycyanurates, polyacrylamides, various epoxies, agar, agarose and any combinations of the above. Additionally, the sol material can be a hybrid material comprising organic and inorganic materials. Such hybrid materials in polymeric form are known in the literature and also further taught in co-pending applications Ser. No. 11/030,014 and Ser. No. 11/030,395. Both of these applications are incorporated here by reference.

In a general the current invention involved forming a sol, which is a colloidal suspension of precursors such as the materials previously mentioned. Such a sol is further combined and optionally mixed with a gelation catalyst. As a non-limiting example, silica sol precursor, tetraethoxysilane (TEOS) is hydrolyzed in an acidic solution and catalyzed to follow a polycondensation in a basic environment to obtain a three dimensional network structure. Such a system as it progresses through the polymerization results in a highly cross-linked network. Fibers in chopped form or as batting, woven, braided, knit or in other forms or such as fabric can be combined with the sol prior to gelation or at a point of gelation when the viscosity of the sol is such that the sol can be infused into such fiber structures with minimal effort. Diluents like aliphatic alcohols, water, ethers or ketones can be added to adjust viscosity or other parameters of such systems. Such additions also take in to account considerations like the resultant expected density of the gel system, expected shrinkage upon drying and the expected final aerogel density. The preferred diluents are water, methanol, ethanol or isopropanol.

In specific embodiments, said catalyzed sols can be poured into a moving belt along with fibers in any of the above mentioned forms and cast into different structures. In a preferred embodiment, they are cast into a sheet such as the ones disclosed in a co-pending U.S. patent application Ser. No. 10/876,103. Such cast-composites still contain diluents. They may be optionally aged for a period of time with optional additives or surface modifying agents such as silylating agents and further dried to remove the diluent without collapsing the underlying structure to substantial degree. Silylating agents include, but not limited to Hexamethyldisilizane, Hexamethyldisiloxane, halosilanes and the like.

Drying can be accomplished at ambient pressures, ambient temperatures, elevated pressures, elevated pressures, supercritical pressures and temperatures, using more than one supercritical fluid, at subzero temperatures or in any combination of the above. The structure of the resultant composite may slightly vary depending on the way the composite is dried. In a preferred embodiment, the composite is dried in a supercritical carbon dioxide environment.

In yet another embodiment, the diluent is replaced by another fluid such as an alcohol, liquid carbon dioxide and the like. In such embodiments, the drying fluid or the supercritical fluid is chosen such that the drying fluid is reasonably miscible with the diluent.

In another embodiment, the fibrous batting can be used in the form of a “lofty” batting as taught by U.S. patent application Ser. No. 10/034,296. Such lofty battings are advantageous in reducing the overall thermal conductivity of the composite.

In yet another embodiment, a method is provided for particulate material prepared via solgel to be made into composites along with fibers disclosed in the current invention preferably without the addition of any external binders. In a preferred embodiment, sol phase and the fiber phase are inextricably intertwined before gelation such that the composite obtained after drying is a coherent composite. In yet another preferred embodiment, sol infusion into the fibrous batting is such that the fiber-fiber direct contact in the batting after sol infusion is reduced by at least 5% and preferably at least 10% compared to the same before sol infusion. Such strategies help reducing any heat transfer through fiber-fiber contact and reduce the overall thermal conductivity of the composite.

In another embodiment, cotton and cellulose based fibers are used as fiber reinforcements. Such fibers can be obtained easily in non-woven, woven, knitted, braided, bengaline, boucle or other forms and incorporated into the aerogel composite structure before any gelation of the sol prepared from various gel precursors. Preferably, Rayon which is a modified cellulose fiber and lycra® which is a cotton based fiber is used in the current invention.

In another embodiment, polyolefins have been used in a variety of applications from kitchens to scientific laboratories. Specifically polyethylenes and polypropylenes in their most common form or in spun bonded form like the commercially available Tyvek®, Typar® or Xavan® can be used in the current invention. Such fibers can be obtained easily in non-woven, woven, knitted, braided, bengaline, boucle or other forms and incorporated into the aerogel composite structure before any gelation of the sol prepared from various gel precursors.

In yet another embodiment, ultra high molecular weight polyolefins can be used in the current invention. Commercially available polymers such as Dyneema® from DSM and Spectra® from Honeywell are such ultra high molecular weight polyethylenes suitable for the current invention. Such fibers can be obtained easily in non-woven, woven, knitted, braided, bengaline, boucle or other forms and incorporated into the aerogel composite structure before any gelation of the sol prepared from various gel precursors.

In yet another embodiment, heat treated polyacrylonitrile fibers can be used in the current invention. Such fibers are disclosed in U.S. Pat. Nos. 5,804,108, 5,853,429, 5,967,770, and U.S. Patent application 20010033035. They further include commercially available fibers like Pyron® and other carbonized or semi-carbonized fibers from Zoltek, SGL Technik, SGL Carbon and other vendors. Such fibers can be obtained easily in non-woven, woven, knitted, braided, bengaline, boucle or other forms and incorporated into the aerogel composite structure before any gelation of the sol prepared from various gel precursors.

In yet another embodiment, polyamides are used. A well-known polyamide is nylon which is available in different forms like Nylon-6, Nylon-66 can be obtained easily in non-woven, woven, knitted, braided, bengaline, boucle or other forms and incorporated into the aerogel composite structure before any gelation of the sol prepared from various gel precursors.

Aramids are among the best known of the high-performance, synthetic, organic fibers. Closely related to the nylons, aramids are polyamides derived from aromatic acids and amines. Because of the stability of the aromatic rings and the added strength of the amide linkages, due to conjugation with the aromatic structures, aramids exhibit higher tensile strength and thermal resistance than the aliphatic polyamides (nylons). The para-aramids, based on terephthalic acid and p-phenylene diamine, or p-aminobenzoic acid, exhibit higher strength and thermal resistance than those with the linkages in meta positions on the benzene rings. The greater degree of conjugation and more linear geometry of the para linkages, combined with the greater chain orientation derived from this linearity, are primarily responsible for the increased strength. The high impact resistance of the para-aramids makes them popular for “bullet-proof” body armor. For many less demanding applications, aramids may be blended with other fibers such as Kevlar® and Nomex®. Aramids like Conex® and Twaron® are also very good fibers for use in the current invention. Such fibers can be obtained easily in non-woven, woven, knitted, braided, bengaline, boucle or other forms and incorporated into the aerogel composite structure before any gelation of the sol.

Polyethylene naphthalate is a speciality polyester whose fiber can be obtained easily in non-woven, woven, knitted, braided, bengaline, boucle or other forms and incorporated into the aerogel composite structure before any gelation of the sol prepared from various gel precursors.

Fluorinated polymers can also be used in the present invention in many forms. Polytetrafluoroethylene commonly known as Teflon is one such form. The same polymer in expanded form has certain enhanced properties used in commercially available fibers like Gore-tex® from W.L.Gore and Associates. Such fibers can be obtained easily in non-woven, woven, knitted, braided, bengaline, boucle or other forms and incorporated into the aerogel composite structure before any gelation of the sol prepared from various gel precursors.

Ceramic fibers are unique in that they are of inorganic origin with very advanced properties. Ceramics of metal oxides, ceramics such as those comprising silica, alumina, boron in various combinations can be manufactured in a fiber form. Nextel® and a silicon carbide fiber called Nicalon® are a few examples. Such fibers can be obtained easily in non-woven, woven, knitted, braided, bengaline, boucle or other forms and incorporated into the aerogel composite structure before any gelation of the sol prepared from various gel precursors. Additionally, metallic fibers such as fibers of iron, aluminum, alloys such as stainless steel can be used in the embodiments of the current invention.

Benzobisoxazole, preferably poly(p-phenylene-2,6-benzobisoxazole) or Zylon® fibers are known to have exceptional thermal stability and non-inflammability. Such fibers can be obtained easily in non-woven, woven, knitted, braided, bengaline, boucle or other forms and incorporated into the aerogel composite structure before any gelation of the sol prepared from various gel precursors.

In yet another embodiment, nonwoven needle punched fabric can be used to prepare the composite of the current invention. A non limiting example is a combination of nylon 6 and nylon 66, which is point thermally embossed, abrasion resistant and marketed as CAMBRELLE®™ fabric, and is manufactured by the Faytex Corp., having a place of business at 185 Libbey Parkway, Weymouth, Mass. 02189.

Thermoplastic fibers are preferred in a specific embodiment by themselves or in combination with other fibers. They can be used as binders when used with other fiber systems. They can be added as chopped fibers in the composites of the current invention. They may melt/plasticize during processing and function as binders of other fiberous elements. Thermoplastics such as polyether sulphone, polyetherimide, polyether ketone, polyphenylene sulphide either individually or in combination with other fibers can be used in the composites of the current invention.

There are numerous possibilities of forming hybrid polymers i.e hybrid of organic-inorganic groups. Such hybrids usually have the advantageous properties of both of its components. Fibers of such hybrids may be obtained easily in non-woven, woven, knitted, braided, bengaline, boucle or other forms and incorporated into the aerogel composite structure before any gelation of the sol prepared from various gel precursors.

The composites of any of the above mentioned embodiments can have further components or additives such as opacifiers, surface modification agents, modulus enhancement agents, flexibility enhancement agents, dust mitigation agents, hydrophobicity or hydrophilicity enhancement agents, combustion resistance agents, radiation absorption or reflection agents and the like. Opacifiers, radiation absorption or reflection agents can be selected from a wide variety of compounds known in the art including but not limited to, carbon black, titanium oxide, iron titanium oxide, zirconium silicate, zirconium oxide, iron (I) oxide, iron (III) oxide, manganese dioxide, iron titanium oxide (ilumenite), chromium oxide, copper manganese iron spinel, silicon carbide Boron Carbide, Diatomite, Manganese ferrite, Nickel oxides, Tin Oxides, Silver Oxides, Bismuth Oxides, Titanium Carbide, Tungsten Oxides or mixtures thereof. Such agents can be in powdered form, particulate form with a desired particle size distribution or they can be cohered with the composite.

The following non-limiting examples provide further insights into the practical aspects of the embodiments and the properties of the resultant composites.

In order to obtain shock resistant composites, silica aerogel was reinforced with Kevlar fabric. Ballistic grade yellow Kevlar fabric of 10 sq in size was infused with silica sols prepared from hydrolyzed tetraethoxysilane as per the embodiments of the current invention.

In order to prepare composites of different thickness, several layers of coupons were impregnated with the sol. After aging in alcohol solution with silylating agent to impart strengthening and hydrophobicity properties (such silation is known in the art and described in literature such as U.S. Pat. No. 3,122,520), the gels were extracted in a supercritical fluid extractor. The Kevlar reinforced aerogel composites showed the following properties (Table 1).

TABLE 1
Properties of Kevlar reinforced silica aerogel composites.

| | Number | | | | |
|---|---|---|---|---|---|
| | of | | | Thermal | Sample |
| | Kevlar | Density | Shrinkage | conduct. | thickness |
| Sample# | layers | (g/cm³) | Factor | (mW/m-K) | (mm) |
| K621 | 7 | 0.30 | 2.0 | 29.5 | 11.5 |
| K4 | 1 | 0.17 | 2.4 | 16.6 | 1.5 |
| K5 | 1 | 0.14-0.15 | * | 23-25 | 1.4-1.7 |
| (10 samples) | | | | | |

Silica aerogels comprising fibrous elements with a target silica density as high as 0.35 g/cc can be prepared in accordance with the present invention. The gels were aged in ethanol for 1-4 days at room temperature, followed by silylation treatment in ethanol in an oven at 50° C. After solvent extraction with supercritical carbon dioxide, the Kevlar reinforced aerogel composites showed the following properties (Table 2):

TABLE 2
Properties of Kevlar reinforced aerogel composites prepared
with high density silica aerogel

| | Number | | | Thermal | Sample |
|---|---|---|---|---|---|
| | of Kevlar | Density | Shrinkage | conduct. | thickness |
| Sample# | layers | (g/cm³) | Factor | (mW/m-K) | (mm) |
| K702 | 7 | 0.44 | 1.2 | 63.8 | 11.9 |
| K703 | 7 | 0.29 | 0 | 27.0 | 11.8 |

An Organically Modified Silicate sol formulation was infused with a woven polypropylene cloth (trade name Swiffer®). The modification agent used was monohydroxy-terminated polydimethysiloxane (PDMS).

The PDMS modified silica sol prepared in 2-propanol was heated at 70° C. for 30 minutes after PDMS incorporation. The ammonia catalyst was added after cooling the mixture to 18° C. The gel was soaked in 2% ammonia solution in 2-propanol for 4 days at room temperature, then aged in a silylating solution in 2-propanol for 3 days at 50° C. The composite had a density of 0.14 g/cc and a thermal conductivity at 100° F. of 18.2 mW/mK.

Nomex, like Kevlar is a fire resistant polyaramid. Sol infused Nomex fabric was prepared using the embodiments of the current invention. After drying the gel, the resulting composite had a density of 0.21 g/cc and a thermal conductivity at 100° F. of 22.4 mW/mK.

Silica sol was infused with various kinds of Gentex fabrics as per the embodiments of the rrent invention. Sol infusion of the fiber was limited to the specific kind of Gentex fabrics chosen which resulted in large thermal conductivity of the products. Further optimization of sol properties and fabric properties is expected to result in much lower thermal conductivities than reported here.

Aging of the gels was performed for 2 h in ammonia and ethanol solution at 50° C., followed by silylating treatment for 2.5 days at 60° C.

TABLE 3
Ch Table 3. Characterization of Gentex reinforced silica aerogel

| Fiber | | Thickness | Density | T.C. |
|---|---|---|---|---|
| Designation | Aspect | (mm) | (g/cc) | (mW/mK) |
| 1299166 | White shiny | 0.20 | 0.74 | 26.1 |
| 71889 | Yellow | 0.79 | 0.24 | 14.9 |
| 1095 | Yellow/aluminized | 0.39 | 0.69 | 19.5 |
| | surface | | | |
| 71870-1 | Greenish | 0.85 | 0.27 | 26.4 |
| | brown | | | |
| 1098 | Greenish | 0.68 | 0.44 | 23.3 |
| | brown/ | | | |
| | aluminized | | | |
| | surface | | | |
| 1299166 | Pink/ | 0.26 | 0.81 | 19.5 |
| 2D-5-11 | aluminized | | | |
| | surface | | | |

The thermal conductivities can be tailored by manipulating the ratio of fiber/aerogel in the composite. The aluminized ones are heavier than their non-aluminized counterparts.

In order to improve the flexibility of the composites, an ormosil (organically modified silica) formulation was used to impregnate both aluminized (Al) and non-aluminized Gentex fibers. The silica sol with 10% of the modifier, PDMS was heated up to 60° C. The rolls were aged and dried supercritically with carbon dioxide as described above. Such 12′×3′ sized, ormosil composites have been tested for conductivity and density (Table 4). The performance of the fiber alone is given for comparison.

TABLE 4
Characterization of Gentex reinforced ormosil blankets

| | T.C. | | T.C. | D | Thickness |
|---|---|---|---|---|---|
| Designation | (mW/mK) | Batch | (mW/mK) | (g/cc) | (mm) |
| 1095yellow | 47.6 | UOKS606 | 19.8 | 0.29 | 0.58 |
| 1095/Al | 31.7 | UOKAIS607 | 28.8 | 0.58 | 0.41 |
| Pink/Al | 182 | UOGS624 | 29.1 | 0.86 | 0.23 |
| 1299166 | 28.8 | | 36.5 | | |
| | 31.2 | | 64.2 | | |
| | | | 42.7 | | |
| | | | 23.5 | | |
| Brown/Al | 68.3 | UOGS625 | 53.2 | 0.47 | 0.60 |
| White | 41.6 | UOGS626 | 39.0 | 0.62 | 0.22 |
| 1299166 | | | 22.1 | | |
| | | | 20.3 | | |
| Brown | 58.5 | UOGS627 | 68.2 | 0.27 | 0.70 |
| | | | 96.4 | | |
| | | | 86.3 | | |
| | | | 29.5 | | |

Non-homogeneous gels, retarded gelation, exfoliation of the aerogel from the aluminized surface and blistering of the aluminized blankets can be avoided by choosing the appropriate fiber and the operating conditions. Variations of the thermal conductivity from spot to spot can be improved by the careful and uniform preparation of the fiber support material. Average thermal conductivity (4 measurements) was reported only when the differences between the recorded data was below 5 mW/mK.

In describing embodiments of the invention, specific terminology is used for the sake of clarity. For purposes of description, each specific term is intended to at least include all technical and functional equivalents that operate in a similar manner to accomplish a similar purpose. Additionally, in some instances where a particular embodiment of the invention includes a plurality of system elements or method steps, those elements or steps may be replaced with a single element or step; likewise, a single element or step may be replaced with a plurality of elements or steps that serve the same purpose. Moreover, while this invention has been shown and described with references to particular embodiments thereof, those skilled in the art will understand that various other changes in form and details may be made therein without departing from the scope of the invention.

1. A composite comprising an aerogel material in coherence with at least one fibrous batting wherein the fiber material is rayon, lycra® or other cotton based fibers; or
wherein the fiber material is Tyvek®, Typar® or Xavan®; or
wherein the fiber material is a heat treated polyacrylonitrile; or
wherein the fiber material is a poly meta or para aramids; or
wherein the fiber material is Conex® or Twaron®; or
wherein the fiber material is Dyneema®; or
wherein the fiber material is Polyethylene naphthalate; or
wherein the fiber material is polyamides; or
wherein the fiber material is nylon; or
wherein the fiber material is expanded PTFE; or
wherein the fiber material is Gore-tex®; or
wherein the fiber material is a ceramic fiber; or
wherein the fiber material is Nextel®, Silicon Carbide or Nicalon®; or
wherein the fiber material is of natural origin, preferably wool, silk, leather or suede; or
wherein the fiber material is benzobisoxazole; or
wherein the fiber material is poly(p-phenylene-2,6-benzobisoxazole) or Zylon®; or
wherein the fiber material is boron, aluminum, iron or stainless steel; or
wherein the fiber material is polyether sulphone, polyetherimide, polyether ketone, polyphenylene sulphide or combinations thereof; or
wherein the fiber material is a hybrid polymer; or
wherein the fibrous material is woven fabric, knit, braid, bengaline, boucle or a combinations thereof; or
wherein the batting is Cambrelle®; or
wherein the batting is a needle punched material.

2-17. (canceled)

18. The composite of claim 1 further comprising radiation opacifiers.

19. The composite of claim 18 wherein opacifer is carbon black, titanium oxide, iron titanium oxide, zirconium silicate, zirconium oxide, iron (I) oxide, iron (III) oxide, manganese dioxide, iron titanium oxide (ilumenite), chromium oxide, copper manganese iron spinel, silicon carbide Boron Carbide, Diatomite, Manganese ferrite, Nickel oxides, Tin Oxides, Silver Oxides, Bismuth Oxides, Titanium Carbide, Tungsten Oxides or mixtures thereof.

20. A composite comprising at least a low density fibrous batting and at least an aerogel material wherein the fiber denier and density are low enough to make the resultant composite translucent; or
wherein the melting point or glass transition point of the fiber is sufficiently low to enable easy forming or shaping of the resultant composite at reasonable temperatures; or
wherein the fiber diameter is less than about 1000 nm.

21-22. (canceled)
